(19) United States
(12) Patent Application Publication
(10) Pub. No.: US 2024/0281142 A1
(43) Pub. Date: Aug. 22, 2024

(54) HIGH BANDWIDTH NON-VOLATILE MEMORY FOR AI INFERENCE SYSTEM

(71) Applicant: MACRONIX INTERNATIONAL CO., LTD., HSINCHU (TW)

(72) Inventors: Hsiang-Lan LUNG, ARDSLEY, NY (US); I-Ting KUO, TAOYUAN (TW)

(73) Assignee: MACRONIX INTERNATIONAL CO., LTD., HSINCHU (TW)

(21) Appl. No.: 18/112,784

(22) Filed: Feb. 22, 2023

(51) Int. Cl. G06F 3/06

(52) U.S. Cl. CPC G06F 3/0613; G06F 3/0659; G06F 3/0679; G06F 13/161; G06F 2213/0062

(57) ABSTRACT

A high bandwidth non-volatile memory (NVM) is described suitable for providing neural network weight data to an AI accelerator processing core or cores. An artificial intelligence (AI) inference memory device employing the high bandwidth NVM technology as described herein can comprise a logic layer die including channel logic implementing connections between a plurality of channels for conducting data to and from an accelerator core via a bus and a plurality of non-volatile memory (NVM) dies stacked vertically one above another, forming a layered vertical stack of NVM dies, each of the NVM dies including at least one memory chip and a plurality of direct vertical connections to a corresponding channel in the logic layer.

### RELATED APPLICATION

This application is being filed concurrently with commonly owned, commonly invented U.S. patent application Ser. No. ______, titled “DATA OPTIMIZATION FOR HIGH BANDWIDTH (HBW) NVM AI INFERENCE SYSTEM”, (Attorney Docket Number MXIC 2347-1), which is incorporated in its entirety herein for all purposes.

### BACKGROUND

### Field

The present invention relates to integrated circuit memory devices, such as non-volatile memory devices, that support storage and retrieval of information used in Artificial Intelligence (AI) inferencing applications, and particularly relates to a layered die memory architecture and command decoder to provide high bandwidth storage and retrieval of weights and other information supporting AI inferencing applications.

### Description of Related Art

Modern information technology applications, such as artificial intelligence (AI) inferencing can consume copious amounts of data such as weighting information in conduct of inferencing operations.

Many different types of memory architectures have been created, each providing storage of digital data and addressing different needs and requirements of a variety of applications. However, conventional approaches to memory devices often suffer from insufficient bandwidth, leading to poor performance, or require refresh logic and are therefore higher in cost.

It is desirable to provide mechanisms for storing AI inferencing data that are capable of greater bandwidths.

### SUMMARY

A high bandwidth non-volatile memory (NVM) is described suitable for providing neural network weight data to an AI accelerator processing core or cores (e.g., accelerator core). An artificial intelligence (AI) inference memory device employing the high bandwidth NVM technology as described herein can comprise a logic layer die including channel logic implementing connections between a plurality of channels for conducting data to and from an accelerator core via a bus and a plurality of non-volatile memory (NVM) dies stacked vertically one above another, forming a layered vertical stack of NVM dies, each of the NVM dies including at least one memory chip and a plurality of direct vertical connections to a corresponding channel in the logic layer.

In a representative implementation, an artificial intelligence (AI) inference memory device, comprises a logic layer die that can include channel logic implementing connections between a plurality of channels for conducting data to and from an accelerator core via at least one bus can be mounted to a substrate. A plurality of non-volatile memory (NVM) dies can be stacked vertically one above another, forming a layered vertical stack of NVM dies. Each of the NVM dies can include at least one memory chip and a plurality of direct vertical connections to a corresponding channel logic in the logic layer. The direct vertical connections can be via-to-via connections of a through silicon via (TSV) integrated circuit. AI inference devices can implement NVMs using any suitable NVM technology such as for example and without limitation a phase change memory (PCM), a three-dimensional cross point memory (3D Xpoint), a NOR flash memory, a resistive random-access memory (RRAM), a magneto-resistive random-access memory MRAM, a ferroelectric random-access memory FeRAM, a conductive bridge random-access memory CBRAM, and a NAND flash memory.

In some implementations, the stacked NVM dies can be organized into one or more banks. A controller in the logic layer can execute interface commands with one or more NVM dies of corresponding banks. Thus, interface commands can be executed by two or more channels in parallel. The interface commands include a read neural network weights data command, and a write neural network weights data command.

In one example implementation, NVM dies are arranged in two stacks of four NVM dies on the logic layer die and provide data to eight parallel channels. Interface commands can be executed by memory corresponding to a plurality of channels in parallel; thereby achieving 50 GB/second throughput to the accelerator core.

In another aspect, the channel logic further includes an interface to a substrate mounting a processor or field programmable gate array (FPGA) that performs neural network computations and a static random-access memory (SRAM) storing activation data for use in neural network computations. Activation data can include for example stored non-linear function(s) for relating relationships between input and output of a neural network, such as for example, a sigmoid function, a hyperbolic tangent (tan h) function, a rectified linear unit (ReLU) function, a leaky rectified linear unit (LReLU) function, and a maxout function. Alternatively, the substrate can mount a processor or a field programmable gate array (FPGA) that performs neural network computations and a dynamic random-access memory (DRAM) storing activation data for use in neural network computations.

In a yet further aspect, the logic layer and vertical stack comprising the plurality of NVM dies can be affixed to an interposer layer. The interposer layer provides connection between the plurality of direct vertical connections of the vertical stack to corresponding channel logic in the logic layer. The AI inference memory device can be packaged as a 2.5D through silicon via (TSV) integrated circuit.

In a still yet further aspect, the logic layer can be affixed to an interposer layer. The plurality of NVM dies are stacked vertically above the logic layer and the interposer layer in a vertical stack; thereby establishing connections between the plurality of direct vertical connections of the vertical stack to corresponding channel logic in the logic layer. The AI inference memory device can be packaged as a three-dimension (3D) through silicon via (TSV) integrated circuit. In some implementations, a plurality of solder bumps that have been deposited onto chip pads of the logic layer and the plurality of NVM dies provide connection with a device immediately below. In some implementations, a plurality of backside interconnects have been deposited onto chip pads of the logic layer and the plurality of NVM dies provide wafer-to-wafer connection with a device above. The AI inference memory device can be packaged as a three-dimensional (3D) system-on-chip (3D SOC) integrated circuit.

In another representative implementation, an artificial intelligence (AI) inference method is provided. The method can be conducted by a processor coupled with a logic layer die including channel logic implementing connections between a plurality of channels conducting data to and from an accelerator core via at least one bus, and a plurality of non-volatile memory (NVM) dies stacked vertically one above another, forming a layered vertical stack of NVM dies, each of the NVM dies including at least one memory chip and a plurality of direct vertical connections to a corresponding channel logic in the logic layer. The method can comprise retrieving from the plurality of NVM dies that are stacked vertically above the logic layer die, a plurality of neural network weights stored therein. Using the accelerator core, the plurality of neural network weights can be applied to input data for each one of a plurality of nodes of a neural network to obtain an intermediate output. Activation data defining an activation function or functions can be applied to the intermediate output to obtain a result for a neural network level. The result can be stored in the plurality of NVM dies, a field programmable gate array (FPGA) buffer, activation memory or any storage device facilitating computations at additional neural network levels until a final result is reached. In embodiments suitable activation data can include stored data implementing an activation function including one or more of a sigmoid function, a hyperbolic tangent (tan h) function, a rectified linear unit (ReLU) function, a leaky rectified linear unit (LReLU) function, and a maxout function. In embodiments, the plurality of NVM dies are arranged in two stacks of four NVM dies on the logic layer die, and wherein the method further comprises providing data to eight parallel channels.

In a further representative implementation, an AI inference system can comprise a processor chip, a first memory chip suitable for storing activation functions, and a second (high bandwidth) memory chip suitable for storing arrays of weights can be coupled together. The processor can apply weights retrieved from the NVM dies to specific inputs and can apply activation functions retrieved from the first memory chip to provide inferencing output. The inference system can be implemented as a multichip module in a single package. The package can be mounted on a circuit board or other type of substrate and connected to sensors and other components that can generate data consumed by the execution of inference processing using the weight data stored in the high bandwidth NVM, and consume data generated by execution of the inference processing.

Other aspects and advantages of the present invention can be seen on review of the drawings, the detailed description, and the claims, which follow.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is an illustration of a multichip module including a high bandwidth memory for AI inferencing as described herein.

FIG. 2 is an illustration of another embodiment of a multichip module including a high bandwidth memory for artificial intelligence (AI) inferencing as described herein.

FIG. 3 is an illustration of yet another embodiment of a multichip module including a high bandwidth memory for AI inferencing as described herein.

FIG. 4 is a simplified functional block diagram of an inference system as described herein.

FIG. 5 is a flowchart of a runtime procedure which can be executed by an inference system as described herein.

FIG. 6 is a simplified functional block diagram of a representative neural network node (neuron) processed by the AI inference system as described herein.

FIG. 7 illustrates representative activation functions suitable for implementing artificial intelligence inferencing as described herein.

FIG. 8 is a simplified diagram illustrating storage and retrieval of weight data in a memory system including a flash memory device implemented on an integrated circuit as described herein.

FIG. 9 illustrates weight data used by a neural network to process images being stored according to various storage paradigms by a high bandwidth non-volatile memory (NVM) in accordance with the technologies as described herein.

FIG. 10 is a schematic illustration of a technique of allocating weight data among multiple NVM channels by a high bandwidth NVM in accordance with the technologies as described herein.

FIG. 11 is a schematic diagram illustrating multiple scenarios for allocating weight data among multiple NVM channels by a high bandwidth NVM in accordance with the technologies as described herein.

### DETAILED DESCRIPTION

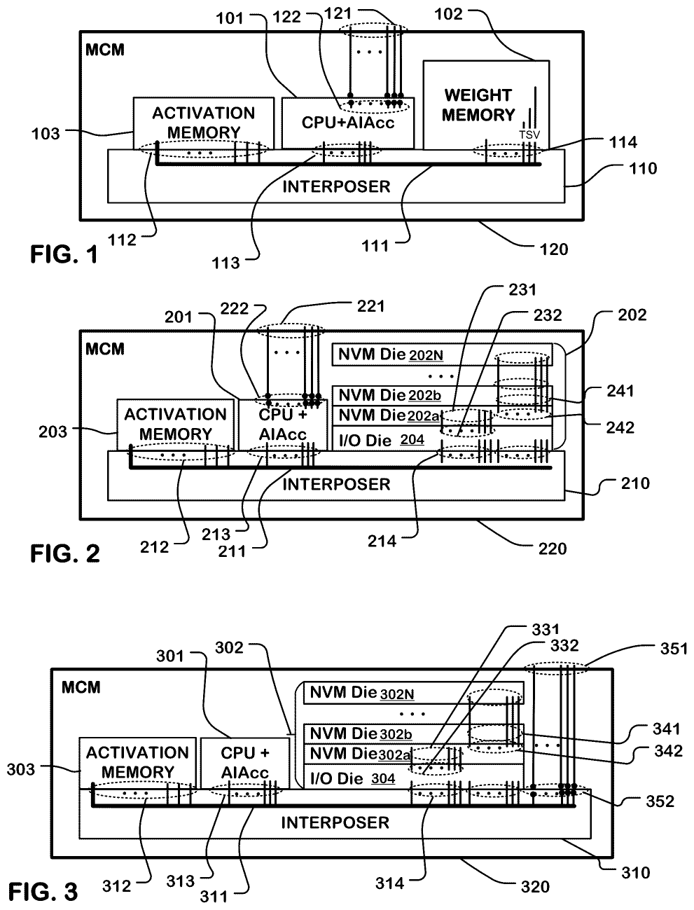

A detailed description of embodiments of the present invention is provided with reference to the FIGS. 1-11.

FIG. 1 illustrates a multichip module (MCM) 120 that includes a processor chip 101, a first memory chip 103 (e.g., an activation memory storing activation data), and second memory chip 102 (e.g., a weight memory storing weight data for a neural network). The weight memory can be considered high bandwidth (HB) memory. In this example, mounted on an interposer 110 are the processor chip 101, the second memory chip 102, which can be a HB non-volatile memory (NVM) for storing weights (e.g., weight data) used in neural network computations, and the first memory chip 103, which can be dynamic random access memory (DRAM), static random access memory (SRAM) or NAND, however DRAM and SRAM are presently preferred options, for storing activation data for activation functions used in neural network computations. The assembly is configured as a multichip module 120 in a single package.

The processor chip 101 can include a runtime processor core (e.g. CPU) and an accelerator core, such as an artificial intelligence accelerator (e.g. AIAcc) or a neuron processing unit.

In this example, processor chip 101 includes an input/output interface 113 disposed on the surface of the chip 101. The input/output interface 113 is connected to interconnection wiring 111 on the interposer 110.

The first memory chip 103 includes an interface 112 for connection to the interconnection wiring 111 on the interposer 110.

The second memory chip 102 includes an interface 114 for connection to the interconnection wiring 111 on the interposer 110. While depicted as a single entity in FIG. 1 for clarity, second memory 102 can comprise multi-layered stack, in which memory dies are disposed on different layers and can be connected to vertical connectors such as through silicon via (TSV) connections to interconnection wiring 111 on the interposer 110.

Thus, interconnection wiring 111 provides part of the data path between the first memory chip 103, the second memory chip 102, and the processor chip 101.

In the example illustrated in FIG. 1, the processor chip 101 includes another input/output interface 122 for connection to external contact structures 121 of the multichip module 120.

FIG. 2 illustrates another configuration of an inference system as described herein. This configuration includes a processor chip 201, a first memory chip 203 (e.g., an activation memory storing activation data), and a second memory chip 202 (e.g., a weight memory storing weight data for a neural network), which can be considered HB memory. In this example, the second memory chip 202 comprises individual layered non-volatile memory (NVM) dies 202a-202N mounted to an I/O die 204 implementing connection logic in a logic layer. The processor chip 201, the I/O die 204 of the second memory chip 202, and the first memory chip 203 are mounted on an interposer 210. The assembly is configured as a multichip module (MCM) 220 in a single package.

The processor chip 201 can include a runtime processor core (e.g. CPU) and an accelerator core, such as an artificial intelligence accelerator (e.g. AIAcc) or a neuron processing unit.

The second memory chip 202 includes the plurality of non-volatile memory dies 202a-202N stacked one on top of another and stacked above the I/O die 204. One such NVM die 202a illustrated includes a chip-to-chip bonding surface on which an interface 231 is exposed for connection to the I/O die 204. The I/O die 204 includes an interface 232 exposed on a surface of the I/O die 204, and complementary to the interface 231 on the NVM die 202a. In this example, direct vertical connections at the surfaces are provided between the memory interface 232 and the interface 231. The direct vertical connections can comprise very short length copper via-to-via conductors or other chip-to-chip contact technologies suitable for high speed, low latency, and low power communication between the chips.

With continuing reference to the second memory chip 202, another NVM die 202b illustrated includes a chip-to-chip bonding surface on which an interface 241 (e.g., an NVM-NVM interface) is exposed for connection to NVM die 202a of the second memory chip 202. The NVM die 202a includes an interface 242 (e.g., an NVM-NVM interface) exposed on a surface of the NVM die 202a, and complementary to the interface 241 on the NVM die 202b. In this example, direct vertical connections at the surfaces are provided between the NVM-NVM interface 242 and the NVM-NVM interface 241.

In some implementations, an interposer layer provides connection between the plurality of direct vertical connections of the vertical stack (e.g., NVM dies 202a-202N) to corresponding channel logic in the logic layer (e.g., I/O die 204). In some implementations, a plurality of solder bumps that have been deposited onto chip pads of the logic layer (e.g., I/O die 204) and the plurality of NVM dies (e.g., 202a-202N) provide connection with a device immediately below. In some implementations, a plurality of backside interconnects have been deposited onto chip pads of the logic layer and the plurality of NVM dies provide wafer-to-wafer connection with a device above. The AI inference memory device can be packaged as any of a 2.5D through silicon via (TSV) integrated circuit, a three-dimension (3D) through silicon via (TSV) integrated circuit and a three-dimensional (3D) system-on-chip (3D SOC) integrated circuit.

In this example, the processor chip 201 includes an input/output interface 213 disposed on the surface of the chip 201. The input/output interface 213 is connected to interconnection wiring 211 on the interposer 210.

The first memory chip 203 includes an interface 212 for connection to the interconnection wiring 211 on the interposer 210.

Also, the I/O chip 204 includes an interface 214 for connection to the interconnection wiring 211 on the interposer 210.

Thus, interconnection wiring 211 provides part of the data path between the first memory chip 203 and the second memory chip 202, and the processor chip 201.

In the example illustrated in FIG. 2, the processor chip 201 includes another input/output interface 222 for connection to external contact structures 221 of the multichip module 220.

FIG. 3 illustrates another configuration of an inference system as described herein. This configuration includes a processor chip 301, a first memory chip 303 (e.g., an activation memory storing activation data), and a second memory chip 302 (e.g., weight memory storing weight data for a neural network), which can be considered HB memory. In this example, the second memory chip 302 comprises individual layered non-volatile memory (NVM) dies 302a-302N mounted to an I/O die 304. The processor chip 301, the I/O die 304 of the second memory chip 302, and the first memory chip 303 are mounted on an interposer 310. The assembly is configured as a multichip module (MCM) 320 in a single package.

The processor chip 301 can include a runtime processor core (e.g. CPU) and an accelerator core, such as an artificial intelligence accelerator (e.g. AIAcc) or a neuron processing unit.

The second memory chip 302 includes the plurality of non-volatile memory dies 302a-302N stacked one on top of another and stacked above an I/O die 304. One such NVM die 302a illustrated includes a chip-to-chip bonding surface on which an interface 331 is exposed for connection to the I/O die 304. The I/O die 304 includes an interface 332 exposed on a surface of the I/O die 304, and complementary to the interface 331 on the NVM die 302a. In this example, direct vertical connections at the surfaces are provided between the interface 332 and the interface 331. The direct vertical connections can comprise very short length copper via-to-via conductors or other chip-to-chip contact technologies suitable for high speed, low latency, and low power communication between the chips.

With continuing reference to second memory chip 302, another NVM die 302b illustrated includes a chip-to-chip bonding surface on which an interface 341 (e.g., an NVM-NVM interface) is exposed for connection to NVM die 302a the second memory chip 302. The NVM die 302a includes an interface 342 (e.g., an NVM-NVM interface) exposed on a surface of the NVM die 302a, and complementary to the interface 341 on the NVM die 302b. In this example, direct vertical connections at the surfaces are provided between the NVM-NVM interface 342 and the NVM-NVM interface 341.

In some implementations, interposer layer 310 provides connection between the plurality of direct vertical connections of the vertical stack (e.g., NVM chips 302a-302N) to corresponding channel logic in the logic layer (e.g., I/O die 304). In some implementations, a plurality of solder bumps that have been deposited onto chip pads of the logic layer (e.g., I/O die 304) and the plurality of NVM dies (e.g., 302a-302N) provide connection with a device immediately below. In some implementations, a plurality of backside interconnects have been deposited onto chip pads of the logic layer and the plurality of NVM dies provide wafer-to-wafer connection with a device above. The AI inference memory device can be packaged as any of a 2.5D through silicon via (TSV) integrated circuit, a three-dimension (3D) through silicon via (TSV) integrated circuit and a three-dimensional (3D) system-on-chip (3D SOC) integrated circuit.

In this example, processor chip 301 includes an input/output interface 313 disposed on the surface of the chip 301. The input/output interface 313 is connected to interconnection wiring 311 on the interposer 310.

The first memory chip 303 includes an interface 312 for connection to the interconnection wiring 311 on the interposer 310.

Also, the I/O chip 304 includes an interface 314 for connection to the interconnection wiring 311 on the interposer 310.

Thus, interconnection wiring 311 provides part of the data path between the first memory chip 303 and the second memory chip 302, and the processor chip 301.

In the example illustrated in FIG. 3, the multichip module (MCM) 320 includes another input/output interface 352 for connection to external contact structures 351 of the multichip module 320.

FIGS. 1-3 provide example arrangements of an inference system with high bandwidth NVM as described herein, showing varieties of configurations of the chips and connections among the chips, the interposer and external contacts of the package. Other arrangements can be implemented as suits a particular need.

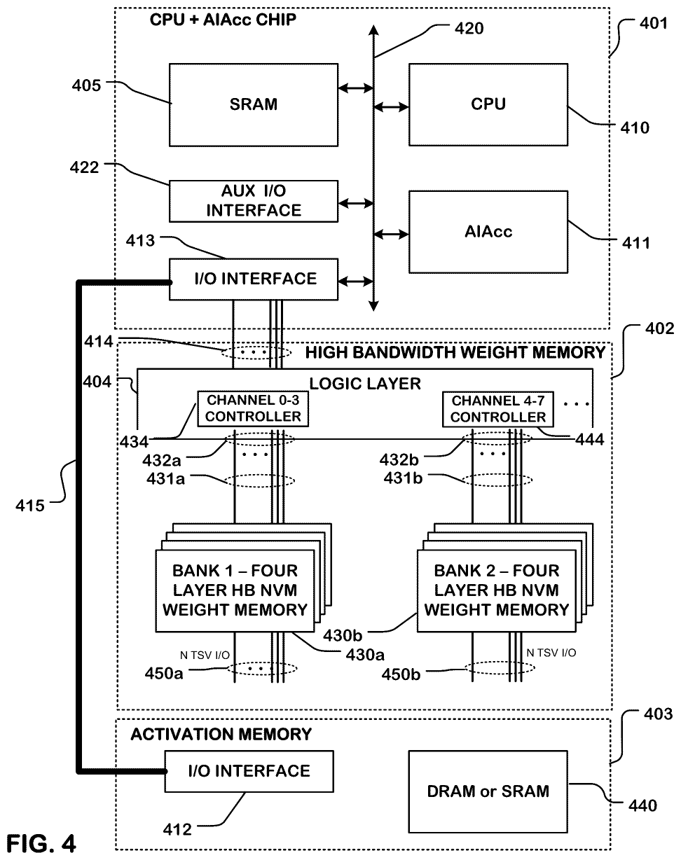

FIG. 4 is a simplified functional block diagram of an inference system implemented as described with reference to FIGS. 1-3. The platform includes a processor chip 401 (e.g., a CPU and an AIAcc), a first memory chip 403 (an activation memory storing activation data), and a second memory chip 402 (e.g., a weigh memory storing weight data for a neural network). The processor chip 401 in this example includes a CPU or processor core 410, accelerator core 411, on-chip memory 405, such as SRAM (or other type of memory) which can be used as working memory and as a cache memory, a first I/O interface 413 and a second I/O interface 422. A bus system 420 provides for intra-chip communications among the components of the processor chip 401.

The first memory chip 403 in this example comprises a high capacity, volatile memory 440 such as DRAM or SRAM (or a nonvolatile memory such as 3D NAND or other type of memory implemented using charge trapping storage technology), for example. The first memory chip 403 includes a first memory I/O interface 412 for off-chip communications. The first memory I/O interface 412 can comprise a high-speed serial port, such as a serial peripheral interface (SPI) compatible port, or a parallel port, depending on the particular implementation of the memory chip 403 that is utilized. A data path 415 is provided in this example between the first memory I/O interface 412, and the first I/O interface 413 on the processor chip 401.

The second memory chip 402, in this example, comprises a high-bandwidth (HB), nonvolatile memory (NVM) configured in one or more banks 430a, 430b, each of which can comprise one or more layers of NVM dies arranged in channels. The NVM can be one of a phase change memory (PCM), a three-dimensional cross point memory (3D Xpoint), and a NAND flash memory. In other examples, the second memory chip 402 can comprise NOR flash memory using charge trapping storage technology, or other suitable random-access technologies like resistive RAM (e.g. metal oxide memory), magnetic RAM, Ferroelectric RAM a conductive bridge random-access memory CBRAM and so on.

The second memory chip 402 includes a memory I/O interface 414 for off-chip communications via a logic layer 404 to the I/O interface 413 on the processor chip 401. Logic layer 404 includes channel controllers 434, 444 that provide control of multiple channels forming one or more sets of high-speed data pathways on which weight data can flow across an interface 432a, 432b exposed on a surface of the logic layer 404, and complementary to the interface 431a, 431b on a surface of banks 430a, 430b of NVM dies arranged in layers direct connected by vertical connections 450a, 450b at the surfaces provided between the IO-memory interface 432a, 432b and the memory-IO interface 431a, 431b. The direct vertical connections 450a, 450b can comprise very short length copper via-to-via conductors or other chip-to-chip contact technologies suitable for high speed, low latency, and low power communication between the chips. In an implementation and by way of example, two stacks are formed by stacking four NVM dies with N/8 through silicon via (TSV) I/O per die onto a logic die; wherein N is the total number of TSV IO, and 8 is number of dies; N/8 is IO per die. One NVM die has one channel; one channel is N/8 through silicon via (TSV) I/O. Each channel is completely independent so each channel can operate independently. One controller can control multiple channels. An external controller can be provided in a field programmable gate array (FPGA) or system on a chip (SoC) die (e.g., implementing processor 401).

DRAM is an option to bond into the system in package (SiP) in case on-chip SRAM is not big enough.

Thermal (heat) management can used to guarantee data retention.

An AI accelerator (e.g. accelerator core 411), as the term is used herein, is a configurable logic circuit including components designed or suitable for execution of some or all of the arithmetic operations of AI inference operations. Configuration of the accelerator core can include loading a set of weights from memory 402 to be used in conducting inference operations, or parts of the set of weights. In some embodiments, configuration of the accelerator core can include loading some or all of the of the computation graphs of an inference model that define the sequence and architecture of the operation of the inference model. The inference model can comprise a computation graph of a deep learning neural network, in some examples having a plurality of fully connected and partially connected layers, activation functions, normalization functions and so on.

An accelerator core can be implemented using configurable logic, like arrays of configurable units used in field programmable gate arrays for example, in which compiled computation graphs are configured using bit files. An accelerator core can be implemented using a hybrid of data flow configurable logic and sequential processing configurable logic.

A runtime processor core (e.g. CPU 410) can execute a runtime program to coordinate operation of the accelerator core to accomplish real time inference operations, including data input/output operations, loading computation graphs, moving the set of weights to be applied in the inference operation into and out of the accelerator core, delivering input data to the accelerator core, and performing parts of the computations to obtain inference results.

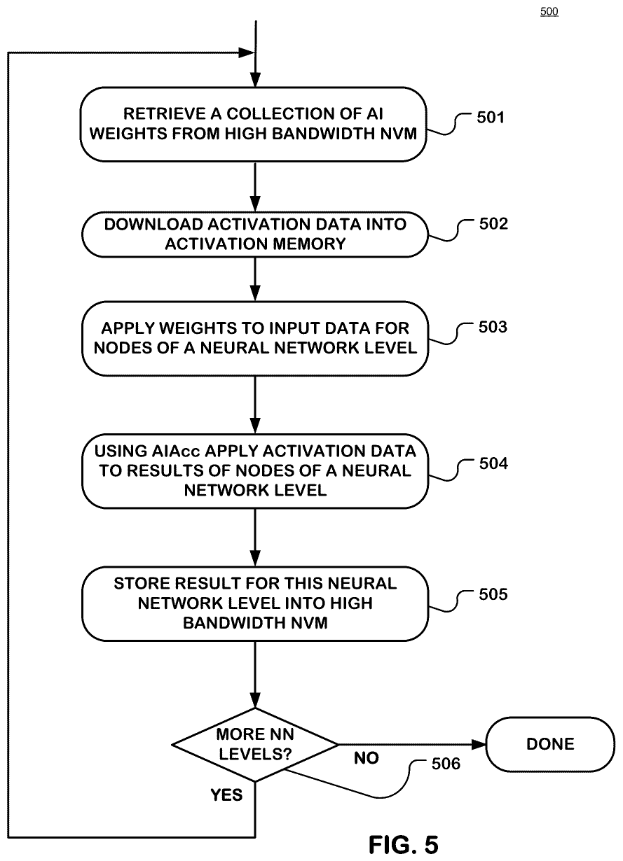

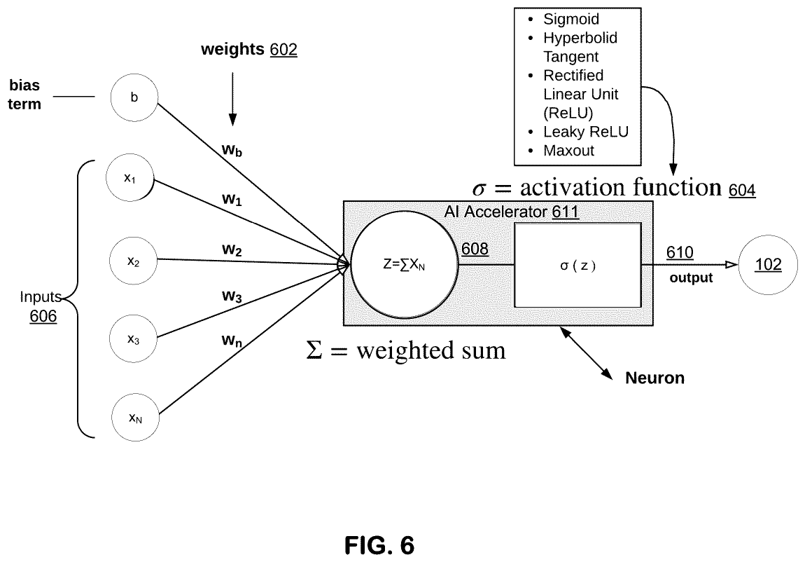

FIG. 5 is a flowchart illustrating an example of logic of operations executed by an inference system, such as described with reference to FIGS. 1-4. FIG. 6 is a simplified functional block diagram of a representative neural network node (neuron) processed by the AI inference system logic as described herein. The logic can be implemented using machine executable instructions stored in memory, such as the SRAM on-chip memory 405, or other memory accessible by the processor 410 coupled with a logic layer die including channel logic implementing connections between a plurality of channels conducting data to and from an accelerator core via at least one bus, and a plurality of non-volatile memory (NVM) dies stacked vertically one above another, forming a layered vertical stack of NVM dies, each of the NVM dies including at least one memory chip and a plurality of direct vertical connections to a corresponding channel logic in the logic layer. In this example, a collection of weights for artificial intelligence neural network computations downloaded from an external source, such as a network, is loaded into the high bandwidth NVM of the inference system.

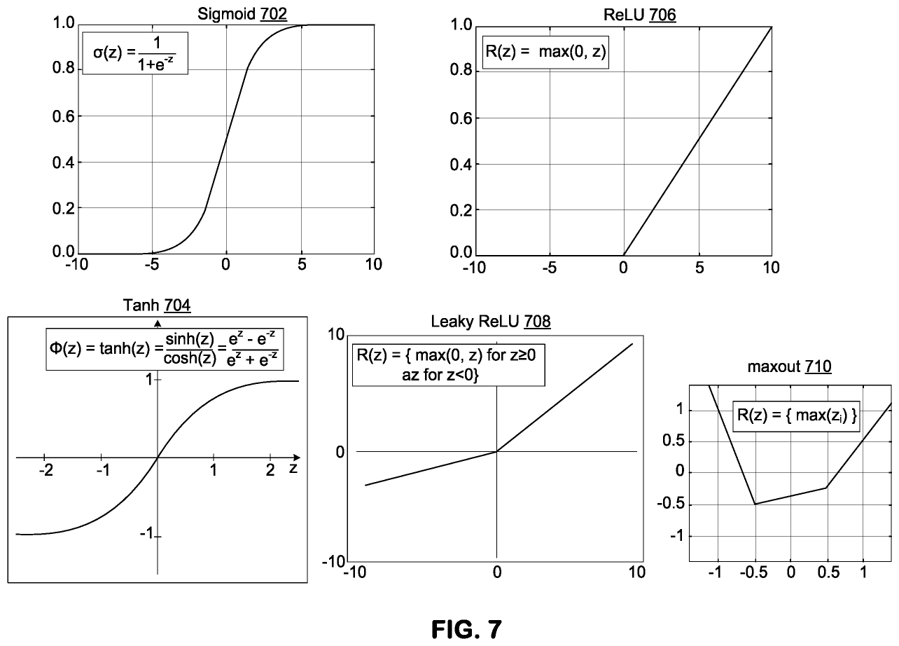

With reference to FIGS. 5, 6, and 7, during runtime, an operation retrieves a plurality of neural network weights 602 (e.g., W_{b}, W₁, W₂, W₃, and Wₙ) stored in the high bandwidth NVM (operation 501). The weight data is directly transferred into the AI accelerator core 611 to perform calculations. An activation function 604 is stored in activation memory (e.g., 403 of FIG. 4) (operation 502). With reference to FIG. 7, suitable activation data can include stored data implementing an activation function including one or more of a sigmoid function 702, a hyperbolic tangent (tan h) function 704, a rectified linear unit (ReLU) function 706, a leaky rectified linear unit (LReLU) function 708, and a maxout function 710.

After loading the weights and configuring the AI accelerator core 611, the operations includes executing an inference procedure using the AI accelerator core 611 to apply the plurality of neural network weights to input data 606 for each one of a plurality of nodes of a neural network to obtain an intermediate output (operation 503) for one or more levels of nodes of the neural network. The intermediate output 608 comprises a set of computational results from a level of the neural network.

Next, the activation function 604 stored in, for example the first memory chip 103 (e.g., activation memory 403 of FIG. 4) is applied to the intermediate output to obtain an output 610 (e.g., a result) for one or more levels of the neural network (operation 504). For example, in operation 504, the AIAcc can apply activation data to results of nodes of a level of a neural network. The result is stored in the high bandwidth NVM, FPGA buffer or any storage device, or activation memory 403 (operation 505). The procedure includes checking if nodes at further neural network levels are to be processed (operation 506) and if so, restarting operations 501-506 for the next batch of neural network nodes to be processed. If there are no further levels to process then the output is provided directly and/or stored (e.g., for storage back in second memory 102, FPGA buffer or any storage device).

Thus, the operations of FIG. 5 include an operation to select activation data and weights stored in the first and second memory chips, into the accelerator core, and to execute the neural network nodes using the weights and activation data. Also, as shown in FIG. 5, after executing or beginning to execute the selected neural network nodes, the operations loop to operation 501, to process a next level of the neural network. If more neural network nodes are to be processed, the operations 501 to 506 are traversed, and can include changing the activation data to a different function, loading the weights for the nodes of the next neural network level, and executing the different nodes.

It will be appreciated with reference to FIG. 5, that many of the steps can be combined, performed in parallel or performed in a different sequence without affecting the functions achieved. In some cases, as the reader will appreciate, a rearrangement of steps will achieve the same results only if certain other changes are made as well. In other cases, as the reader will appreciate, a rearrangement of steps will achieve the same results only if certain conditions are satisfied. Furthermore, it will be appreciated that the flow charts herein show only steps that are pertinent to an understanding of the invention, and it will be understood that numerous additional steps for accomplishing other functions can be performed before, after and between those shown.

During training processing, weights stored in NVM dies (e.g., of the weights memory 402) are adjusted by the processor chip 401 (e.g., a CPU and an AIAcc) based upon training dataset(s). As training progresses, the processor chip 401 will keep updating values for the weights and this value will be stored in the NVM. In some implementations, weights are fixed during inference processing.

In process constrained environments, speed in which the AI application arrives at a result becomes an important factor. Thus conventional randomly stored weight data in the HBW NAND flash could increase data fetching operations required and lead to low data transmission efficiency due to the page-level granularity inherent to NAND flash page read operations. Weight data storage paradigms in accordance with embodiments described herein can reduce flash access times and increase data process efficiency.

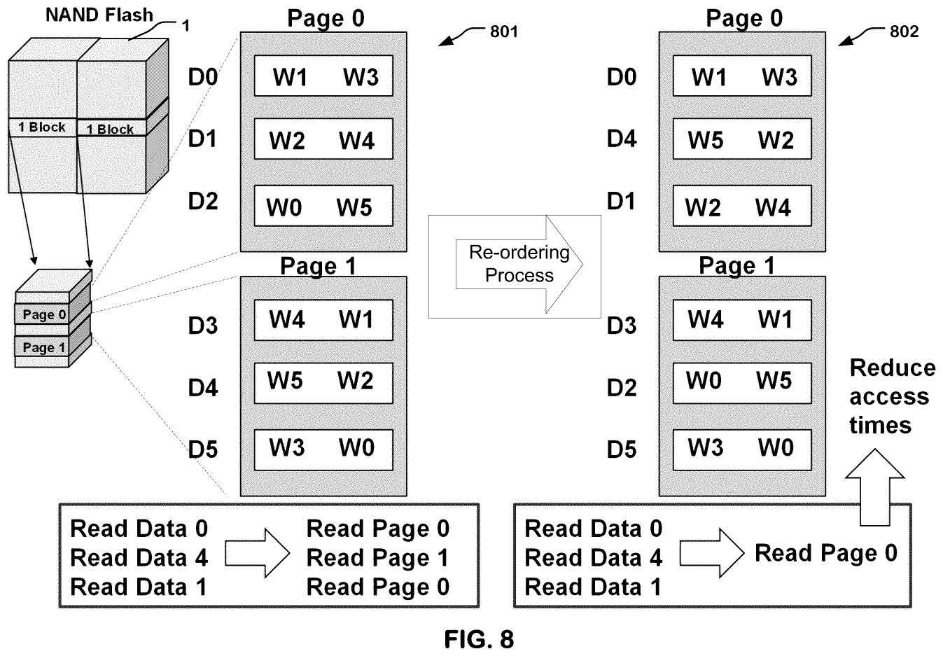

FIG. 8 is a simplified diagram illustrating storage and retrieval of weight data used to compute node values during inferencing operations conducted by a neural network in a memory system including a flash memory device 1 implemented on an integrated circuit as described herein. The memory device can be implemented on a single integrated circuit chip, on a multichip module, or on a plurality of chips configured to suit a particular need.

As shown in FIG. 8, memory device 1 is a NAND flash in which read operations are performed at a one-page granularity, meaning that every time a fetch operation for data is performed, one whole page must be read from the flash. Data fetching can become slow when data is stored in different pages. This may impact the process speed of the entire AI inferencing platform. Further, the AI accelerator may stall and wait for data to arrive. This can result in low bandwidth utilization if locality of the data is not well preserved.

Continuing with FIG. 8, D0 to D5 indicate data storage locations; W0 to W5 indicate weight data. The weight data was stored in the NVM. In a first scenario 801, weight data (i.e., neural network weights) are stored randomly in data locations from location D0 to location D5 in page 0 and page 1. Accordingly, if neural network processing calls for Data 0, Data 4, and Data 1, e.g., weights W1 and W3, W5 and W2 and W2 and W4, to perform a calculation, i.e., obtain a node value or set of node values, then the NAND flash memory device 1 will read page 0 first, in order to obtain Data 0, e.g., weights W1 and W3, then read page 1, in order to obtain Data 4, e.g., weights W5 and W2, and then go back to re-read page 0, in order to obtain Data 1, e.g., weights W2 and W4. However, if the data is stored in data locations in accordance with an expected retrieval indicated by the neural network to be processed, or re-ordered to be in such storage locations, as illustrated by second scenario 802, expected data acquisition times can be reduced. In second scenario 802, weights belonging to Data 0, Data 4 and Data 1, e.g., (W1, W3), (W5, W2), and (W2, W4) respectively, are all stored in locations in page 0. Thus, obtaining weights belonging to Data 0, Data 4 and Data 1 calls for the NAND flash memory device 1 to perform a single read of page 0, which reduces access time, increases efficiency, increases performance, etc. In various implementations, the structure of the neural network, which indicates which weights are to be used and in what order, can be received as an input by the AI inferencing system, read from storage, or otherwise made accessible. Because the whole neural network structure can be obtained from a local storage on chip, received from a host or another chip in the AI inferencing system, the AI inferencing system can determine what weight data needs to be input during AI inference, and thus in what order the weight data can be stored in order to reduce access times during later inferencing.

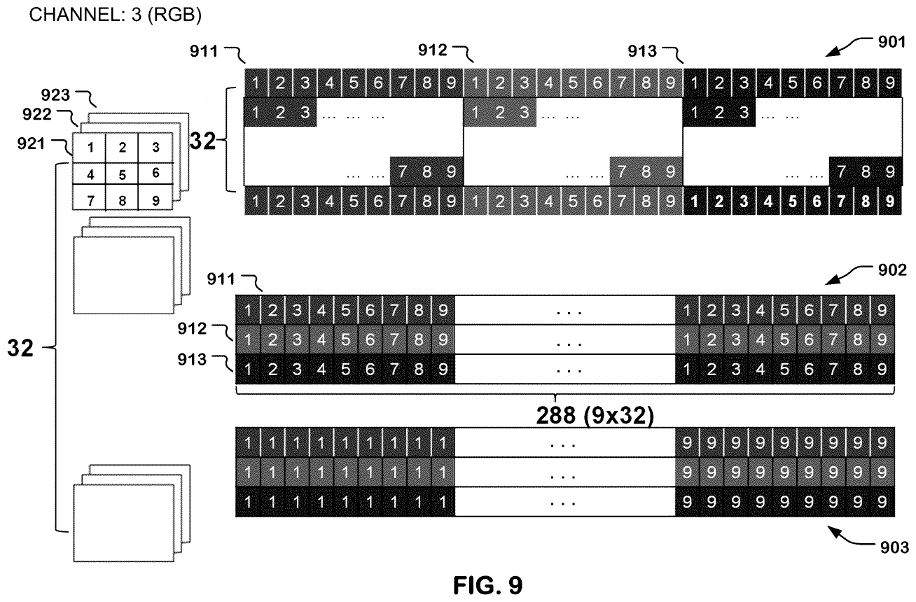

FIG. 9 illustrates weight data used by a neural network to process images being stored according to various storage paradigms by a high bandwidth NVM in accordance with the technologies as described herein. In the example implementation illustrated by FIG. 9, weight data is stored in the same page or multiple pages in the NVM and read in groups or sets of nine (9) weights for each of three (3) color neural network channels: red (1 to 9), green (1 to 9) and blue (1 to 9). A group (or set) of weights can comprise a filter or a feature map such that the filter can include weights that correspond to network nodes in a layer of the neural network defined in a neural network definition.

In the example storage paradigms 901, 902, 903 illustrated by FIG. 9, there are 32 sets of 9 weights, each having a specific storage location, where a set of 9 weights 911, 912, 913 forms a respective 3×3 filter, e.g., 921, 922, 923. A set of 9 red weights 911 can be used to populate a red filter 921, a set of green weights 912 can be used to populate a green filter 922, and a set of blue weights 913 can populate a blue filter 923. Accordingly, there are 288 red weights (e.g., 32×9), 288 green weights and 288 blue weights. In sum, there is a total of 864 weights (288×3).

As depicted in FIG. 9, weights are stored from left to right in the diagram, which is from red to green to blue in paradigm 901. Accordingly, in paradigm 901, 3 fetch instances are needed to retrieve the first filter of 3 different, i.e., red, green, and blue channels, because, for example, this data might not be stored in the same page in memory, depending on the page size. Accordingly, for example, to populate each of the filters at least 96 read operations (32×3) will be required. If the weights are all stored in the same page, this processing can still require 3 read operations to obtain values for a filter for 3 different (e.g., R, G, and B) channels. That's why the order of the data can be re-arranged so that an AI inferencing engine can process all of the red data at once, if one page is large enough to hold all red data. If the page size is not large enough to hold the weights for all filters of the same color, the remainder of the same color weights will be stored continuing onto the next page in memory.

When the weight data is stored according to a first storage paradigm 901, resulting read processing that is of lower efficiency may result. If data location can be arranged (or re-arranged) and stored in a different ordering, such as paradigms 902, 903, then weight data can be read in once for red, green and blue filters. This will reduce data fetching times, resulting in decreased processing time during inferencing when the data needs to be read.

In paradigm 902, 9 weights for a red filter 911, 9 weights for a green filter 912 and 9 weights for a blue filter 913 have been stored together. In this configuration, a read operation can obtain weights to populate filters 921, 922, and 923 in a single read operation.

In paradigm 903, weights are arranged with all Is grouped together, then all 2s grouped together, and so forth. This is another data re-arrangement to improve access when performing convolution processing. The input image will multiply 3×3 filter to do convolution processing.

Of course, while 3×3 filters are used in this example illustrated by FIG. 9, filters could be constructed having practically any size, such as for example and without limitation embodiments that implement filters of 5×5, 8×8, in which cases, there would be 25, or 64, etc. total weight values per filter.

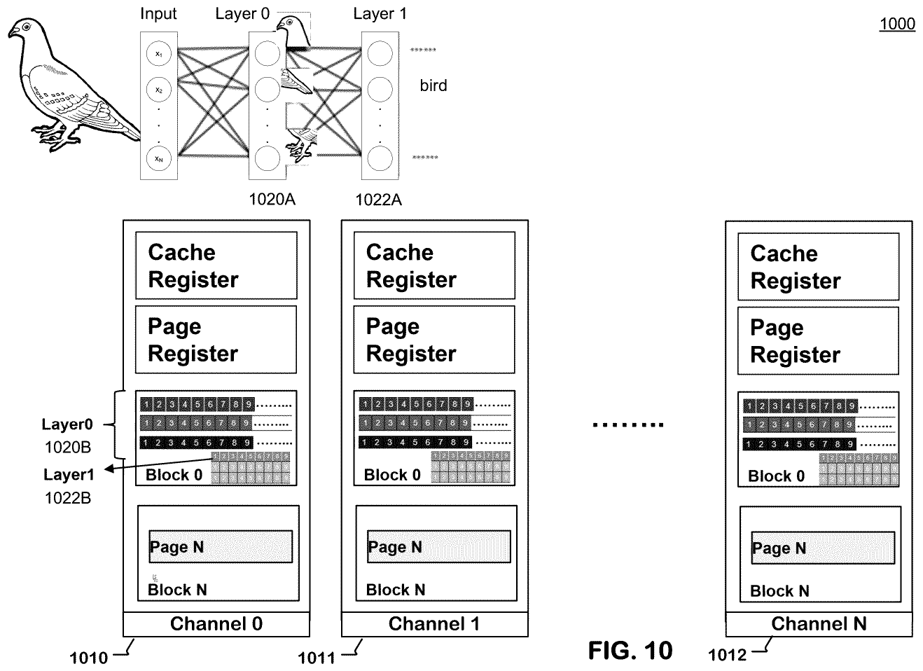

FIG. 10 is a schematic illustration of a technique of allocating weight data among multiple NVM channels by a high bandwidth NVM in accordance with the technologies as described herein. High bandwidth memory architecture 1000 illustrated by FIG. 10 incorporates the use of channels 1010, 1011, 1012 to enable data to be read from or stored to different NVM dies carrying memory arrays contemporaneously. Such memory channels used for data transfer along pathways to and from dies implementing non-volatile storage arrays. In some implementations, the controller can be shared by, i.e., can control, multiple channels as illustrated by 434, 444 in FIG. 4, which control channels 0-3 and channels 4-7 respectively.

In an implementation and by way of example, if a memory system has 4 channels, or multichannel NVM memory, the total weight data length can be distributed equally or otherwise among the memory channels (data length/channel). Of course, utilization of page size can be maximized using the techniques described above with reference to FIGS. 8-9. For example: 288 weights per neural network channel, e.g., 288 red weights (e.g., 32 filters×9 weights per filter), can be distributed among 4 memory channels, yielding 72 red weights per each memory channel, or 72 red weights/9 weights per filter yields 8 red filters per memory channel. Analogously, 8 green filters per memory channel; and 8 blue filters per memory channel.

Further, different layers of the neural network will employ different groups of weights. As shown in FIG. 10, for example, in the convolutional neural network (CNN), there are different layers 1020A, 1022A. For each layer, there are different filters 1020B, 1022B. Here, layer 0 is the first layer 1020A in convolutional neural network and corresponds to the first layer filter (weights) 1020B are stored in the page 0. If page 0 is not large enough, the weights data will be stored at a following page. Further, weights can be of a different type, and function for the different layers. For example, weights associated with layer 0 1020B include weights grouped according to red, green and blue filters. Layer 1 1022A includes weights grouped according to some other paradigm defined by the neural network definition. In some implementations, the weights corresponding to a first layer of a neural network can be stored according to one paradigm (e.g., 901, 902, or 903 of FIG. 9) and weights corresponding to a second layer of the neural network can be stored according to a different paradigm.

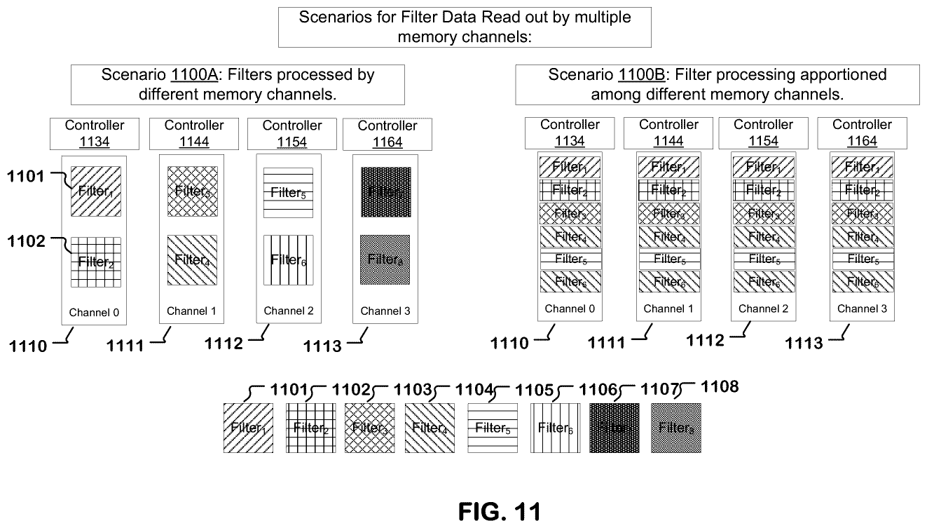

FIG. 11 is a schematic diagram illustrating multiple scenarios for allocating weight data among multiple NVM channels by a high bandwidth NVM in accordance with the technologies as described herein. Appropriate storage scenarios according to the present technology can provide for retrieval of the weights for two or more groups of weights (e.g., filters) without necessitating a read of an additional page of memory. For example, weights can be stored such that retrieval of all groups for the layer can be performed without necessitating triggering additional page of memory. In FIG. 11, weight data belonging to a plurality of filters (filter 1-filter 7) 1101-1108 can be read out by multiple memory channels (channel 0-channel 3) 1110-1113. A memory channel is used for data transfer via pathways to and from dies implementing non-volatile storage arrays. In some implementations, the controller can be shared by, i.e., can control, multiple channels as illustrated by 434, 444 in FIG. 4, which control channels 0-3 and channels 4-7 respectively.

In scenario 1100A, weights grouped according to filters can be allocated to individual memory channels. For example, the weights for filter 1 1101 and filter 2 1102 are stored for retrieval by channel 0 1110. Accordingly, weights from filters can be stored to or retrieved from multiple arrays contemporaneously using multiple NVM channels. In this configuration, weights belonging to different filters can be read contemporaneously using different channels, however, if weights from different groups assigned to the same channel need to be read, for example from filter 1 and filter 2 in scenario 1100A of FIG. 11, both belonging to channel 0 1110, then multiple page reads might need to occur.

In scenario 1100B, weights grouped according to filters are allocated to storage space across different channels. With reference to FIG. 11, the weights for filter 1 through filter 6 1101-1106 are apportioned among each of the four available channels (channel 0-channel 3) 1110-1113. In this scenario, weight data distributed among the multiple channels can be read in contemporaneously from NVM arrays by each of channel 0 through channel 3 1110-1113. Further, read operations against the NVM arrays of each channel have the capability to read weight data for each of the filters without necessitating a page retrieval when switching read operations from one filter to the next filter.

Other implementations of the method described in this section can include a non-transitory computer readable storage medium storing instructions executable by a processor to perform any of the methods described above. Yet another implementation of the method described in this section can include a system including memory and one or more processors operable to execute instructions, stored in the memory, to perform any of the methods described above.

Any data structures and code described or referenced above are stored according to many implementations on a computer-readable storage medium, which may be any device or medium that can store code and/or data for use by a computer system. This includes, but is not limited to, volatile memory, non-volatile memory, application-specific integrated circuits (ASICs), field-programmable gate arrays (FPGAs), magnetic and optical storage devices such as disk drives, magnetic tape, CDs (compact discs), DVDs (digital versatile discs or digital video discs), or other media capable of storing computer-readable media now known or later developed.

As used herein, a network node, including network nodes referred to as client side nodes and a server side nodes, is an application hosted on an active electronic device, or virtual device executed in an active electronic device such as a cloud-based platform, that is attached to a network, and is capable of sending, receiving, or forwarding information in support of computer programs such as servers and clients, over a physical media for a communications channel on the network, and having for example media access control addresses and protocol stacks that support higher network layers. A network can include the networks using Internet Protocol addresses, or other type of network layer addresses. In some embodiments the network comprises the Internet. Examples of electronic devices which can host network nodes, include all varieties of computers, workstations, laptop and desktop computers, hand-held computers and smart phones, and cloud-based platforms.

A byte is a basic storage unit used in many integrated circuit logic and memory circuits and consists of eight bits. Basic storage unit can have other sizes, including for example one bit, two bits, four bits, 16 bits and so on. Thus, the description of a high bandwidth NVM set out above, and in other examples described herein utilizing the term byte, applies generally to circuits using different sizes of storage units, as would be described by replacing the term byte or set of bytes, with storage unit or set of storage units. Also, in some embodiments different sizes of storage units can be used in a single command sequence, such as one or more four-bit storage units combined with eight-bit storage units.

A number of flowcharts illustrating logic executed by a memory controller or by memory device are described herein. The logic can be implemented using processors programmed using computer programs stored in memory accessible to the computer systems and executable by the processors, by dedicated logic hardware, including field programmable integrated circuits, and by combinations of dedicated logic hardware and computer programs. With all flowcharts herein, it will be appreciated that many of the steps can be combined, performed in parallel or performed in a different sequence without affecting the functions achieved. In some cases, as the reader will appreciate, a re-arrangement of steps will achieve the same results only if certain other changes are made as well. In other cases, as the reader will appreciate, a re-arrangement of steps will achieve the same results only if certain conditions are satisfied. Furthermore, it will be appreciated that the flow charts herein show only steps that are pertinent to an understanding of the invention, and it will be understood that numerous additional steps for accomplishing other functions can be performed before, after and between those shown.

While the present invention is disclosed by reference to the preferred embodiments and examples detailed above, it is to be understood that these examples are intended in an illustrative rather than in a limiting sense. It is contemplated that modifications and combinations will readily occur to those skilled in the art, which modifications and combinations will be within the spirit of the invention and the scope of the following claims.

What is claimed is:

1. An artificial intelligence (AI) inference memory device, comprising:
a logic layer die including channel logic implementing connections between a plurality of channels for conducting data to and from an accelerator core via at least one bus; and
a plurality of non-volatile memory (NVM) dies stacked vertically one above another, forming a layered vertical stack of NVM dies, each of the NVM dies including at least one memory chip and a plurality of direct vertical connections to a corresponding channel logic in the logic layer.

2. The AI inference memory device of claim 1, wherein the stacked NVM dies are organized into one or more banks, and further including for each bank, a controller to execute interface commands with one or more NVM dies of corresponding banks of the one or more banks.

3. The AI inference memory device of claim 2, wherein the interface commands are executed by two or more channels in parallel.

4. The AI inference memory device of claim 2, wherein the interface commands include a read neural network weights data command, and a write neural network weights data command.

5. The AI inference memory device of claim 1, wherein the plurality of NVM dies are arranged in two stacks of four NVM dies on the logic layer die, and provide data to eight parallel channels.

6. The AI inference memory device of claim 5, wherein interface commands are executed by memory corresponding to a plurality of channels in parallel; thereby achieving 50 GB/second throughput to the accelerator core.

7. The AI inference memory device of claim 1, wherein the corresponding channel further includes an interface to a substrate mounting a processor or field programmable gate array (FPGA) that performs neural network computations and a static random-access memory (SRAM) storing activation data for use in neural network computations.

8. The AI inference memory device of claim 7, wherein storing activation data includes storing a non-linear function for relating relationships between input and output of a neural network.

9. The AI inference memory device of claim 7, wherein storing activation data includes storing data implementing an activation function selected from at least one of a sigmoid function, a hyperbolic tangent (tan h) function, a rectified linear unit (ReLU) function, a leaky rectified linear unit (LReLU) function, and a maxout function.

10. The AI inference memory device of claim 1, wherein the corresponding channel further includes an interface to a substrate mounting a processor or a field programmable gate array (FPGA) that performs neural network computations and a dynamic random-access memory (DRAM) storing activation data for use in neural network computations.

11. The AI inference memory device of claim 1, wherein the NVM is one of a phase change memory (PCM), a three-dimensional cross point memory (3D Xpoint), a NOR flash memory, a resistive random-access memory (RRAM), a magneto-resistive random-access memory MRAM, a ferroelectric random-access memory FeRAM, a conductive bridge random-access memory CBRAM, and a NAND flash memory.

12. The AI inference memory device of claim 1, wherein the direct vertical connections comprise via-to-via connections of a through silicon via (TSV) integrated circuit.

13. The AI inference memory device of claim 1, further including an interposer layer to which the logic layer and a vertical stack comprising the plurality of NVM dies are affixed; wherein the interposer layer provides connection between the plurality of direct vertical connections of the vertical stack to corresponding channel logic in the logic layer; thereby packaging the AI inference memory device as a 2.5D through silicon via (TSV) integrated circuit.

14. The AI inference memory device of claim 1, further including an interposer layer to which the logic layer is affixed; wherein the plurality of NVM dies are stacked vertically above the logic layer and the interposer layer in a vertical stack; thereby establishing connections between the plurality of direct vertical connections of the vertical stack to corresponding channel logic in the logic layer; thereby packaging the AI inference memory device as a three-dimension (3D) through silicon via (TSV) integrated circuit.

15. The AI inference memory device of claim 14, wherein a plurality of solder bumps that have been deposited onto chip pads of the logic layer and the plurality of NVM dies provide connection with a device immediately below.

16. The AI inference memory device of claim 14, wherein a plurality of backside interconnects have been deposited onto chip pads of the logic layer and the plurality of NVM dies provide wafer-to-wafer connection with a device above; thereby packaging the AI inference memory device as a three-dimensional (3D) system-on-chip (3D SOC) integrated circuit.

17. An artificial intelligence (AI) inference method conducted by a processor coupled with a logic layer die including channel logic implementing connections between a plurality of channels conducting data to and from an accelerator core via at least one bus, and a plurality of non-volatile memory (NVM) dies stacked vertically one above another, forming a layered vertical stack of NVM dies, each of the NVM dies including at least one memory chip and a plurality of direct vertical connections to a corresponding channel logic in the logic layer, the method comprising:
retrieving from the plurality of NVM dies that are stacked vertically above the logic layer die, a plurality of neural network weights stored therein;
using the accelerator core, applying the plurality of neural network weights to input data for each one of a plurality of nodes of a neural network to obtain an intermediate output;
applying activation data to the intermediate output to obtain a result for a neural network level; and
storing the result in at least one of the plurality of NVM dies, an FPGA buffer, and an activation memory facilitating computations at additional neural network levels until a final result is reached.

18. The AI inference method of claim 17, wherein applying activation data includes applying stored data implementing an activation function selected from at least one of a sigmoid function, a hyperbolic tangent (tan h) function, and a rectified linear unit (ReLU) function.

19. The AI inference method of claim 17, wherein the plurality of NVM dies are arranged in two stacks of four NVM dies on the logic layer die, and wherein the method further comprises providing data to eight parallel channels.

20. An AI inference system, comprising:
a substrate coupling:
a processor chip,
a first memory chip suitable for storing activation functions, and
an artificial intelligence (AI) inference memory device for storing arrays of weights, the memory device comprising:
a logic layer die including channel logic implementing connections between a plurality of channels for conducting data to and from an accelerator core via at least one bus; and
a plurality of non-volatile memory (NVM) dies stacked vertically one above another, forming a layered vertical stack of NVM dies, each of the NVM dies including at least one memory chip and a plurality of direct vertical connections to a corresponding channel logic in the logic layer;
wherein the processor applies weights retrieved from the NVM dies to specific inputs and applies activation functions retrieved from the first memory chip to provide inferencing output; and
wherein the inference system is implemented as a multichip module in a single package.
